(19) United States
(12) Patent Application Publication
(10) Pub. No.: US 2014/0295162 A1
(43) Pub. Date: Oct. 2, 2014

(54) Metal Collecting Material

(71) Applicants: ASAHI KASEI CHEMICALS CORPORATION, Tokyo (JP); JAPAN ATOMIC ENERGY AGENCY, Ibaraki (JP)

(72) Inventors: Taro Suzuki, Tokyo (JP); Noriaki Seko, Gunma (JP); Masao Tamada, Gunma (JP); Seiichi Saiki, Gunma (JP); Naohiko Inatomi, Chiba (JP)

(73) Assignees: ASAHI KASEI CHEMICALS CORPORATION, Tokyo (JP); JAPAN ATOMIC ENERGY AGENCY, Ibaraki (JP)

(21) Appl. No.: 14/225,605

(22) Filed: Mar. 26, 2014

(30) Foreign Application Priority Data
Mar. 27, 2013 (JP) P2013-065992

(51) Int. Cl. B01J 20/28; B01J 20/22; B01J 20/24; C02F 1/28

(52) U.S. Cl. CPC B01J 20/28038; C02F 1/286; B01J 20/22; B01J 20/24; C02F 2101/20
USPC 428/219

(57) ABSTRACT

The present invention relates to a metal collecting material formed of an organic polymer fiber base material into which a functional group having a metal adsorbing function is introduced, in which the metal collecting material has a nonwoven fabric form, an opening diameter of 10 to 300 μm, an aperture ratio of 10 to 50%, a thickness of 10 to 500 μm, and a weight per area of 5 to 25 g/m², and a fiber diameter of the organic polymer fiber is 5 to 50 μm.

### BACKGROUND OF THE INVENTION

1. Field of the Invention

The present invention relates to a metal collecting material used for the purpose of recovering or removing useful or harmful metal dissolved in a liquid. More specifically, the present invention relates to a metal collecting material that selectively collects an intended metal element at high speed and in large quantity, from a liquid in which a large variety of metal elements are dissolved.

2. Related Background Art

Mineral ores have been gathered from mines and refined so that useful metals such as scandium, vanadium, and uranium have been used as metal resources. However, reserves of mine resources of each metal have a limit, bias of distribution between areas is large in certain metals, and thus, supply to market may often be unstable. Accordingly, such useful metals have large price fluctuation and a risk of generating an imbalance between demand and supply.

In place of mines, potential was seen in hot spring water or seawater, resources of which exist nearly unlimited, and many researches for recovering useful elements dissolved therein only in a small amount have been conducted (Patent Literature 1). Among them, a metal collecting material to which a functional group that forms a chelate with an intended metal element is imparted is remarkable for insusceptibility to many coexisting elements and capability of exhibiting high selectivity. Moreover, for the purpose of removing harmful metals, a chelate forming-type collecting material is effective (Patent Literature 2).

[Patent Literature 1] Japanese Patent Application Laid-Open No. 2006-26588

[Patent Literature 2] Japanese Patent Application Laid-Open No. 2011-125853

### SUMMARY OF THE INVENTION

Patent Literature 1 discloses a metal collecting material capable of recovering a large variety of useful metals dissolved in hot spring water. Patent Literature 2 discloses a water treatment nonwoven fabric filter which exhibits an effect of removing a metal and organic matter. However, since these metal collecting material and nonwoven fabric filter have low contact efficiency with a liquid, there is a disadvantage that a collecting speed is slow, resulting in a problem that a long period of time is required for collecting. Furthermore, in order to compensate the lowness of the contact efficiency, a measure in which a liquid is brought into contact with the metal collecting material by being pressurized with a pump or the like was generally used, and therefore, there was also a problem that a lot of energy is consumed. On the other hand, in the case of using a coagulation-sedimentation method or a bead-like collecting material, handling was difficult in removing or operations thereafter, and there was also an environmental pollution problem in a refining process after collecting.

It is an object of the present invention to provide a metal collecting material capable of selectively collecting specific metal at high speed and in large quantity so as to industrially recover or remove useful or harmful metal dissolved in a liquid. More specifically, it is an object of the present invention to provide a metal collecting material that can collect an intended metal element by a simple contact method, excels in handling ability, and has low environmental load caused by falling of the metal collected, dissipation of the collecting material due to breaking or tearing of the collecting material, or the like.

These objects are achieved by the following present invention. (1) A metal collecting material formed of an organic polymer fiber base material into which a functional group having a metal adsorbing function is introduced, in which the metal collecting material has a nonwoven fabric form, an opening diameter of 10 to 300 μm, an aperture ratio of 10 to 50%, a thickness of 10 to 500 μm, and a weight per area of 5 to 25 g/m², and a fiber diameter of the organic polymer fiber is 5 to 50 μm.

(2) The metal collecting material according to the above-described (1), in which the functional group is introduced by using a graft polymerization method using radiation or plasma treatment.

(3) The metal collecting material according to the above-described (1) or (2), in which a degree of swelling when collecting metal is 150 to 2000%.

(4) The metal collecting material according to any one of the above-described (1) to (3), in which the organic polymer fiber is cellulose.

(5) The metal collecting material according to the above-described (4), in which the cellulose is viscose rayon or cuprammonium rayon.

According to the present invention, a metal collecting material capable of industrially recovering or removing useful or harmful metal dissolved in a liquid can be provided. By only placing the collecting material in the flow of hot spring water or seawater, a liquid can easily permeate through the thickness into the inside, and thus, the collecting process can be finished in a short time. Moreover, the collecting material can perform metal collecting without using power of a pump, and contributes to energy saving. Furthermore, in the case where cellulose or polylactic acid which is a biodegradable base material is used as a base material, the amount of chemicals and heat used can be reduced in volume reduction when being disposed.

### DESCRIPTION OF THE PREFERRED EMBODIMENTS

Hereinafter, preferred embodiments of the present invention will be described.

Firstly, a preferred embodiment of a metal collecting material of the present invention is characterized by including a functional group having a metal adsorbing function which is introduced to an organic polymer fiber base material having a nonwoven fabric form by graft polymerization using radiation or plasma treatment, that is, a graft chain composed of a monomer having mainly a vinyl group and a chelate forming group introduced into the graft chain. The collecting material of the present invention is characterized by having a high collecting capacity and collecting speed, and selectivity for various metals can be imparted by appropriately changing a chelate forming group to be introduced into the organic polymer fiber base material of the collecting material.

### Organic Polymer Fiber Base Material

The organic polymer fiber base material is obtained by making a nonwoven fabric form out of polymer fiber by a known method. Although the polymer fiber is not particularly limited as long as a functional group can be introduced thereinto by graft polymerization, examples thereof include fibers such as polyolefins, such as polyethylene and polypropylene, cellulose, and polylactic acid. Among them, cellulose fiber is preferable, and regenerated cellulose fiber including viscose rayon or cuprammonium rayon is further preferable. The organic polymer fiber base material may be composed of a plurality of kinds of these fibers, and furthermore, may be cross-linked by radiation treatment or the like. The fiber may be a core-in-sheath structure, and for example, may be fiber having a core-in-sheath structure in which the inner core is made of polypropylene and the outer core is made of polyethylene.

Examples of documents describing the known method for producing nonwoven fabric from polymer fiber include “Basic Knowledge for Nonwoven Fabric written by Toshikazu Shinohara, Tsuyoshi Fukuoka, Tetsuya Kato and edited by Taiji Mukaiyama, Nikkan Kogyo Shimbun, Ltd., 2012” and “Product and Application of Nonwoven Fabrics edited by Yoshio Nakamura, CMC Publishing Co., Ltd., 2000”.

A nonwoven fabric having a desired opening diameter, aperture ratio, thickness, and weight per area can be produced from desired fiber having a desired diameter by using these known methods. For example, a nonwoven fabric having a desired thickness and weight per area can be obtained by adjusting a fiber supplying speed or a spinning speed, and a web drawing speed.

Since monomers are added by radiation graft polymerization to increases the fiber diameter, in producing the fiber base material for the metal collecting material of the present invention, the fiber base material needs to be produced such that, for example, the fiber diameter is smaller and the weight per area is lower than desired values as the collecting material. The fiber diameter and the weight per area after graft polymerization correspond well to the amount of the monomer added, and thus, the desired values of the fiber diameter and weight per area can be determined in advance by calculation.

### Monomer Having Vinyl Group

The monomer having a vinyl group contains one or more vinyl groups in the molecule, and can be introduced into the organic polymer fiber base material as a graft chain by graft polymerization. Although not particularly limited, it is preferable that the monomer having a vinyl group contain, in the molecule, one or more chelate forming groups described below or groups that can be easily converted into chelate forming groups. Accordingly, in the former case, the collecting material can be produced by a two-step reaction in which a reaction active point is generated in the organic polymer fiber base material and graft polymerization of the monomer is performed, and in the latter case, the collecting material can be produced by a three-step reaction in which a reaction active point is generated, graft polymerization of the monomer is performed, and a chelate forming group is introduced into a graft chain.

The monomer having a vinyl group can be appropriately selected and used depending on the kind of the chelate forming group.

In the case where the chelate forming group is a phosphate group, although not particularly limited, it is preferable that the monomer having a vinyl group be mono(2-methacryloyloxyethyl) acid phosphate: CH₂=C(CH₃)C(CH₂)₂OPO(OH)₂, di(2-methacryloyloxyethyl) acid phosphate: [CH₂=C(CH₃)COO(CH₂)₂O]₂PO(OH), mono(2-acryloyloxyethyl) acid phosphate: CH₂=CHCOO(CH₂)₂OPO(OH)₂, di(2-acryloyloxyethyl) acid phosphate: [CH₂=CHCOO(CH₂)₂O]₂PO(OH), or mixed monomers thereof. In the case of using the mixed monomers, the mixture ratio of the respective monomers can be appropriately changed. Alternatively, a monomer having the following formula:
CH₂=C(CH₃)COO(CH₂)₁OCO—R—CO—OPO(OH)_{R′},
   (wherein, R is (CH₂)ₘ or C₆H₄ that may have a substituent group, R′ is a hydroxyl group or a CH₂=C(CH₃)COO(CH₂)ₙOCO—R—CO—O- group, and 1, m, and n are each independently an integer of 1 to 6) may be used.

Since the graft chain introduced by these vinyl monomers generally has a cross-linked structure and the chelate forming group described below and metal are strongly bonded thereto, it is advantageous in that the graft chain is less susceptible to interference of other coexisting metals once being bonded, a stable recovery ratio can be obtained, and high efficiency can be achieved.

In the case where the chelate forming group is an iminodiacetic acid group, an amidoxime group, or an amino group, although not particularly limited, it is preferable that the monomer having a vinyl group be selected from the group consisting of allylamine, glycidyl acrylate, glycidyl methacrylate, N-vinyl acetamide, acrylonitrile, methacrylonitrile, or mixtures thereof.

### Chelate Forming Group

The chelate forming group in the present invention means a functional group capable of forming a chelate with metal to be recovered or removed. Although not particularly limited, examples of the chelate forming group include a phosphate group, an iminodiacetic acid group, an amidoxime group, an amino group, or a functional group obtained by supporting zirconium or iron on a phosphate group. The chelate forming group can be appropriately selected among these in accordance with an intended metal element. There have been numerous reported on a group that efficiently forms a chelate with an intended element, and examples thereof include “R. D. Hancock, A. E. Martell Chem. Rev. 1989, 89, 1875-1914”.

Although not particularly limited, examples of the group that can be converted into a chelate forming group include a glycidyl group, a cyano group, and a phosphate group.

### Production Method of Metal Collecting Material

The metal collecting material can be produced by (1) a step of generating a reaction active point in an organic polymer fiber base material, (2) a step of graft polymerizing a monomer onto the organic polymer fiber base material, and if necessary, (3) a step of introducing a chelate forming group into a graft chain.

(1) Reaction for Generating Reaction Active Point

The reaction active point is generated in the organic polymer fiber base material by the following method (a) or (b) so as to graft polymerize the monomer onto the organic polymer fiber base material.

(a) Radiation Irradiation Treatment

The organic polymer fiber base material is cooled at room temperature or using dry ice and irradiated with radiation under a deoxygenated atmosphere. The radiation used is an electron ray or a gamma ray, and the irradiation dose can be appropriately determined as long as it is a dose enough to generate the reaction active point.

Although not particularly limited, the irradiation dose is typically 5 to 200 kGy.

(b) Plasma Irradiation Treatment

The organic polymer fiber base material is irradiated with plasma under a nitrogen atmosphere. There have been numerous reports on treatment using plasma, and examples thereof include “Plasma Polymerization, written and edited by Yoshihito Osada, Tokyo Kagaku Dozin, 1986”.

(2) Graft Polymerization Reaction

Graft polymerization is performed by bringing the monomer into contact with the organic polymer fiber base material in which the reaction active point is generated under a deoxygenated atmosphere, thereby to introduce a graft chain of a reactive monomer into the organic polymer fiber base material. Since oxygen in the system inhibits graft polymerization, the reaction is preferably performed under a nitrogen atmosphere, and the oxygen concentration in the atmosphere is preferably low so as to achieve a high graft ratio. The graft ratio in the present invention means the amount of a weight increase (%) when the reactive monomer is graft polymerized onto the organic polymer fiber base material. The reaction temperature is dependent on the reactivity of the monomer, and is typically 40 to 60° C. The reaction time is normally about several hours to several days, and can be appropriately determined such that a desired degree of swelling is obtained. Although the monomer concentration may be usually around 10%, it is a factor for determining the reaction rate along with the reaction temperature and the reaction time, and thus, can be appropriately determined.

(3) Reaction for Introducing Chelate Forming Group

In the case where a reactive monomer having a chelate forming group is not used in the graft polymerization reaction, by reacting a compound having a chelate forming group with the graft chain, the chelate forming group can be introduced into the graft chain.

The reaction time can be determined depending on the density of the chelate forming group to be obtained by the reaction. For example, in the case where glycidyl methacrylate is used as a reactive monomer in the graft polymerization reaction, by reacting a compound having an amino group, such as ethylenediamine, guanidine hydrochloride, and allylamine, a collecting material having an amino group (amino-type collecting material) in which the amino group is introduced into the graft chain can be produced. As the compound having an amino group, for example, allylamine can be suitably used. The reaction time can be determined depending on the density of the amino group to be obtained by the reaction.

As a preferred embodiment of a method for recovering or removing useful or harmful metal dissolved in a liquid of the present invention, it is preferable that the collecting material be placed in and brought into contact with the liquid flow. Since the opening diameter, aperture ratio, fiber diameter and the like of the metal collecting material of the present invention are suitably controlled, the liquid can be easily made to permeate the metal collecting material in the thickness direction, and for example, the metal collecting material can be used by being placed in the flow of hot-spring discharge. Naturally, the liquid may be made to permeate the metal collecting material forcibly using a pump or the like. Furthermore, in another embodiment, the metal collecting material may be soaked in a liquid while stirring forcibly.

### Useful or Harmful Metal

Useful or harmful metal to be recovered or removed by the present invention is not particularly limited as long as it is metal dissolved in a liquid, and examples thereof include lithium, beryllium, sodium, magnesium, potassium, calcium, chromium, copper, zinc, rubidium, strontium, indium, barium, lanthanum, cerium, praseodymium, neodymium, europium, gadolinium, terbium, dysprosium, holmium, erbium, thulium, ytterbium, ruthenium, thallium, bismuth, thorium, arsenic, scandium, gallium, cesium, gold, platinum, silver, vanadium, palladium, rhodium, yttrium, nickel, cobalt, aluminum, molybdenum, tungsten, uranium, antimony, selenium, mercury, lead, cadmium, samarium, iron, and manganese. Among these metals, examples of the metal that is desired to be recovered or removed because of being especially useful or harmful include arsenic, scandium, gallium, cesium, gold, platinum, silver, vanadium, palladium, rhodium, yttrium, nickel, cobalt, aluminum, molybdenum, tungsten, uranium, antimony, selenium, mercury, lead, cadmium, samarium, iron, and manganese.

The metal recovered by the collecting material of the present invention can be eluted with inorganic acids, organic acids, or organic solvents. The collecting material after elution is washed with pure water and then, alternately soaked in hydrochloric acid and aqueous sodium hydroxide having appropriate concentrations so that the collecting material can be reused. Since the collecting material of the present invention forms therein a cross-linked structure and has a stable structure by using a graft polymerization technique, the collecting material has little damage due to adsorption and desorption, and can be repeatedly used.

### Evaluation Method of Metal Collecting Material

(1) Opening Diameter

The metal collecting material was vacuum dried at 30° C. for 12 hours or more, and about 2 mm×5 mm was cut out therefrom and it was attached and fixed to a stage by conductive double-faced tape for an electron microscope. Furthermore, silver paste for an electron microscope was applied to four corners of the collecting material for conduction to the stage, and ion sputtering using gold as a target was performed (Hitachi, Ltd., E-1010). With respect to 50 openings selected at random, a length and width were measured using a scanning electron microscope (Hitachi, Ltd., SEMEDX typeN). Collecting material fiber is likely to exist also at the back of the respective openings when the collecting material is thick, but in the present invention, collecting material fiber that is not developed as an electron microscope image is ignored to define an opening An average value of the length and width of each opening is determined as the opening diameter, and an average value of the 50 openings was calculated and determined as the opening diameter of the collecting material. In the present invention, the opening diameter is 10 μm to 300 μm, and preferably 30 μm to 150 μm.

(2) Aperture Ratio

An observation by a scanning electron microscope was performed in the same manner as the above-described opening diameter, and an image was output on a paper medium and weighed (weight A). The opening on the paper medium was cut out and weighed (weight B). The aperture ratio was determined by the following equation.

Aperture ratio (%)=100×B/A

In the present invention, the aperture ratio is 10% to 50%, and preferably 20% to 30%.

(3) Fiber Diameter

An observation by a scanning electron microscope was performed in the same manner as the above-described opening diameter, with respect to 50 points selected at random, measurement of a fiber diameter was performed, and an average value thereof was calculated and determined as the fiber diameter of the collecting material.

In order to achieve the above-described opening diameter and aperture ratio, in the present invention, the fiber diameter of the organic polymer fiber into which a functional group having a metal adsorbing function is introduced is 5μm to 50 μm. A smaller fiber diameter increases a specific surface area and is advantageous to metal collecting, but on the other hand, in the case where the fiber diameter is small, the opening diameter and aperture ratio tend to become small, and permeability of a liquid into the collecting material may be decreased. As a result, metal collecting performance of the collecting material as a whole may be decreased. The above-described fiber diameter is important so as to achieve comprehensively high metal collecting performance.

(4) Thickness

The metal collecting material was vacuum dried in the same manner as the above-described opening diameter measurement, and measurement was performed by a thickness gauge (Mitutoyo Corporation, 7301).

In the present invention, the thickness is 10 μm to 500 μm, and preferably 10 μm to 100 μm.

(5) Weight per Area

The collecting material dried in the same manner as the above-described opening diameter measurement was cut out into a square of 3 cm×3 cm and weighed. A weight per area was determined as a weight per unit area (unit is g/m²).

In the present invention, the weight per area is 5 g/m² to 25 g/m², and preferably 10 g/m² to 20 g/m².

A thinner thickness and a lower weight per area are advantageous to collecting an intended element because a liquid can be uniformly brought into contact with the fiber of the metal collecting material. However, in order to impart more mechanical strength to the metal collecting material in accordance with usage environment, it is necessary to increase the thickness within the above-described range and to increase the weight.

(6) Degree of Swelling

The metal collecting material was cut out into 3 cm×3 cm, and it was soaked in a liquid for 24 hours under the same conditions as collecting evaluation described below (Qualitative and Quantitative Evaluation of Collected Metal) and then taken out. This was pressed and sandwiched by paper waste such that the adhered liquid is absorbed, and rapidly weighed (weight C). Furthermore, the collecting material was vacuum dried at 30° C. for 12 hours or more and weighed (weight D). The degree of swelling when collecting metal was determined by the following equation.

Degree of swelling (%)=100×(C−D)/D

By appropriately controlling physical properties such as the graft ratio using the degree of swelling in the state of collecting the intended metal as a new index, a high collecting speed and collecting capacity can be achieved. It is known that, in the respective fibers of the metal collecting material, the chelate forming groups are uniformly distributed on the cross-sections, and it was necessary to effectively use the chelate forming groups in the central part of the fibers as a high-speed and large-capacity collecting material. In the present invention, the object was achieved by appropriately controlling physical properties such as the graft ratio using the degree of swelling of the fiber as an index. The degree of swelling in the collecting state is preferably 150% to 2000%, and further preferably 200% to 1400%. In order to perform a higher-speed collecting, it is necessary to select a high degree of swelling within this range, and in order to increase mechanical strength of the collecting material, it is necessary to select a low degree of swelling within this range.

(7) Qualitative and Quantitative Evaluation of Collected Metal

The metal collecting material that had been soaked in a liquid containing an intended metal element for predetermined hours was cut out into about 2×2 cm, and it was washed with purified water. This was dried in the same manner as the above-described opening diameter measurement and then, was weighed. After that, it was mixed with an undiluted solution of nitric acid (Kanto Chemical Co., Inc., ultrahigh-purity reagent, nitric acid 1.42), and wet degradation was performed using a microwave sample preparation system (Milestone General K.K., ETHOS900, maximum 500 W) to obtain a homogeneous solution. The solution was appropriately diluted with 0.5% nitric acid (described above, diluted with ultrapure water), and qualitative and quantitative evaluations were performed using ICP-AES (Perkin Elmer, Optima 4300 DV) or ICP-MS (Seiko Instruments Inc., SPQ9700). In the quantitative evaluation, the amount collected per collecting material weight after drying was determined (unit is g/kg (collecting material): that is, the amount of metal collected (g) per unit collecting material (kg)).

Hereinafter, the present invention will be further described with reference to examples, but the present invention is not limited to these examples.

### EXAMPLES

Next, specific examples of the present invention will be described.

### Example 1

Production of Nonwoven Fabric

Polypropylene (Asahi Kasei Chemicals Corporation) and polyethylene (same, Suntec™-HD) were used at the weight ratio of 50:50. Conjugated yarn was produced by a melt spinning method using them, and then, a nonwoven fabric having a width of 30 cm was produced by an air-through method.
Preparation of Monomer Solution

2-Methacroyloxyethyl acid phosphate (Kyoeisha Chemical Co., Ltd., LIGHT ESTER P-2M) was adjusted to a monomer concentration of 20% with a mixed solvent of methanol and pure water (methanol 20 wt %). Nitrogen bubbling was performed for 30 minutes or more in a gas-washing bottle.
Electron Ray Irradiation

In a plastic bag with a zipper, 1.21 g of the above-described nonwoven fabric was put, the inside thereof was substituted with nitrogen, and the plastic bag was air-tightly sealed. The plastic bag fixed on dry ice was irradiated with a 200 kGy electron ray accelerated to 2 MV.
Graft Polymerization

To a reaction container, 100 g of the above-described monomer solution and the electron ray irradiated nonwoven fabric were rapidly transferred, the atmosphere was substituted with nitrogen such that the oxygen concentration in the container is 10 ppm or less, and then, the container was air-tightly sealed. This was fixed in a thermostatic bath controlled to 60° C. and made to be reacted for 12 hours. This graft polymerization sample was taken out and washed with methanol (Wako Pure Chemical Industries, Ltd., first grade reagent). Then, vacuum drying was performed at 30° C. for 12 hours to obtain 3.05 g of the graft polymerization sample.
Structure Evaluation

According to the measurement of the respective items based on the above-described method, the opening diameter was 92 μm, the aperture ratio was 19%, the fiber diameter was 23 μm, the thickness was 102 μm, the weight per area was 16 g/m², and the degree of swelling was 630%.
Qualitative and Quantitative Evaluation of Collected Metal

The amount of scandium collected was evaluated. The collecting material was put in 1 L of hot spring water at room temperature, obtained from Kusatsu Onsen in Gunma Prefecture (pH 1.72, scandium concentration 36 ppb) to be stirred by a magnetic stirrer. Hot spring water was changed every hour, and soaking was continued for 8 hours. According to the evaluation of the amount of scandium collected based on the above-described method, it was 0.56 g/kg (collecting material).

### Example 2

Production of Nonwoven Fabric

A nonwoven fabric having a width of 30 cm was produced by performing digestion, washing, foreign body removal, paper making, and drying of vein fiber of sisal hemp. This was dried by hot air at 50° C.
Preparation of Monomer Solution 70 parts by weight of acrylonitrile (manufactured by Kanto Chemical Co., Inc., special grade reagent), 30 parts by weight of methacrylic acid (manufactured by Kanto Chemical Co., Inc., first grade reagent), and 100 parts by weight of N, N-dimethylsulfoxide (Kishida Chemical Co., Ltd., reagent) were mixed, and nitrogen bubbling was performed for 30 minutes or more in a gas-washing bottle.
Electron Ray Irradiation

In the same manner as Example 1, 1.87 g of the above-described nonwoven fabric was irradiated with a 20 kGy electron ray.
Graft Polymerization

Graft polymerization was performed by reacting the above- described electron ray irradiated nonwoven fabric sample and 100 g of the above-described monomer solution in the same manner as Example 1. However, the reaction temperature was 40° C. and the reaction time was 48 hours. With respect to the obtained graft polymerization sample, methanol washing and vacuum drying were performed in the same manner as Example 1 to obtain 3.20 g of the graft polymerization sample.
Introduction of Chelate Forming Group

3 parts by weight of hydroxylamine hydrochloride (Kanto Chemical Co., Inc., special grade reagent) was mixed and dissolved in 48.5 parts by weight of methanol (Wako Pure Chemical Industries, Ltd., first grade reagent) and 48.5 parts by weight of purified water (Kyoei Pharmaceutical Co., Ltd.), and further neutralized with potassium hydroxide (Wako Pure Chemical Industries, Ltd., special grade reagent, granular) to be pH 7.0. In a reaction container with a reflux apparatus, 200 g of the neutralized solution was put and heated to 80° C., and 1.91 g of the above-described graft polymerization sample was put therein to be reacted for 1 hour. The sample was taken out and washed with purified water, and then, methanol, and dried in a vacuum drier at 30° C. for 12 hours. Then, 2.5 wt % of an aqueous potassium hydroxide solution was prepared from potassium hydroxide (Wako Pure Chemical Industries, Ltd., special grade reagent, granular) and purified water (Kyoei Pharmaceutical Co., Ltd.). The aqueous solution was put in the reaction container with a reflux apparatus and heated to 80° C., and the above-described sample was put therein to be reacted for 30 minutes. After that, the sample was washed with purified water until pH becomes less than 11. A part of the sample was cut out for evaluation, and air-tightly sealed and stored with a small quantity of purified water so as to prevent from drying out.
Structure Evaluation

According to the measurement of the respective items based on the above-described method, the opening diameter was 106 μm, the aperture ratio was 23%, the fiber diameter was 15 μm, the thickness was 48 μm, the weight per area was 14 g/m², and the degree of swelling was 160%.
Qualitative and Quantitative Evaluation of Collected Metal

The amount of vanadium collected was evaluated. The collecting material was placed and soaked in the flow at 10 cm/sec of sand-filtrated seawater controlled to 25° C., for 28 days. According to the evaluation of the amount of vanadium collected based on the above- described method, it was 3.2 g/kg (collecting material).

### Example 3

Production of Nonwoven Fabric

Regenerated cellulose long fiber was produced by a cuprammonium rayon method, using cotton linter as a raw material, and a nonwoven fabric having a width of 30 cm was produced by a hydroentangled method. This was dried by hot air at 50° C.
Preparation of Monomer Solution

Preparation was performed in the same manner as Example 2.
Electron Ray Irradiation

1.57 g of the above-described nonwoven fabric was irradiated with an electron ray in the same manner as Example 1 (50 kGy).
Graft Polymerization

Graft polymerization was performed by reacting the above-described electron ray irradiated nonwoven fabric sample and 100 g of the above-described monomer solution in the same manner as Example 1. However, the reaction temperature was 40° C. and the reaction time was 48 hours. With respect to the obtained graft polymerization sample, methanol washing and vacuum drying were performed in the same manner as Example 1 to obtain 2.91 g of the graft polymerization sample.
Introduction of Chelate Forming Group

Introduction was performed in the same manner as Example 2.
Structure Evaluation

According to the measurement of the respective items based on the above-described method, the opening diameter was 98 μm, the aperture ratio was 19%, the fiber diameter was 18 μm, the thickness was 89 μm, the weight per area was 18 g/m², and the degree of swelling was 200%.
Qualitative and Quantitative Evaluation of Collected Metal

The amount of uranium collected was evaluated. The collecting material was soaked in sand-filtrated seawater for 28 days in the same manner as Example 2. According to the evaluation of the amount of uranium collected based on the above-described method, it was 3.0 g/kg (collecting material).

### Comparative Example 1

Synthesis and evaluation of the collecting material were performed in the same manner as Example 1 except that a melt-blow method was used in producing the nonwoven fabric. Regarding the obtained collecting material, the opening diameter was 26 μm, the aperture ratio was 8%, the fiber diameter was 3 μm, the thickness was 63 μm, the weight per area was 20 g/m², and the degree of swelling was 540%. The amount of scandium collected was 0.22 g/kg (collecting material).

### Comparative Example 2

Synthesis and evaluation of the collecting material were performed in the same manner as Example 2 except that the repeating number of paper making steps was increased in producing the nonwoven fabric. Regarding the obtained collecting material, the opening diameter was 37 μm, the aperture ratio was 11%, the fiber diameter was 20 μm, the thickness was 210 μm, the weight per area was 54 g/m², and the degree of swelling was 190%. The amount of vanadium collected was 1.3 g/kg (collecting material).

### Comparative Example 3

Synthesis and evaluation of the collecting material were performed in the same manner as Example 3 except that a spinning speed of a spinning liquid into hot water was increased and a net transfer speed of a subsequent laminating step was decreased in producing the nonwoven fabric. Regarding the obtained collecting material, the opening diameter was 230 μm, the aperture ratio was 31%, the fiber diameter was 55 μm, the thickness was 580 μm, the weight per area was 110 g/m², and the degree of swelling was 120%. The amount of uranium collected was 1.5 g/kg (collecting material).

TABLE 1

| | | Comparative | | Comparative | | Comparative |
|---|---|---|---|---|---|---|
| | Example 1 | Example 1 | Example 2 | Example 2 | Example 3 | Example 3 |
| materials for base material | polypropylene + | | vein fiber | | regenerated cellulose | |
| | polyethylene | | of sisal hemp | | (cotton linter) | |
| opening diameter | 92 | 26 | 106 | 37 | 98 | 230 |
| (μm) | | | | | | |
| aperture ratio | 19 | 8 | 23 | 11 | 19 | 31 |
| (%) | | | | | | |
| fiber diameter | 23 | 3 | 15 | 20 | 18 | 55 |
| (μm) | | | | | | |
| thickness | 102 | 63 | 48 | 210 | 89 | 580 |
| (μm) | | | | | | |
| weight per area | 16 | 20 | 14 | 54 | 18 | 110 |
| (g/m²) | | | | | | |
| degree of swelling | 630 | 540 | 160 | 190 | 200 | 120 |
| (%) | | | | | | |
| amount collected | 0.56 | 0.22 | 3.2 | 1.3 | 3 | 1.5 |
| (g/kg (collecting material)) | | | | | | |
| collected metal | (Sc) | (Sc) | (V) | (V) | (U) | (U) |

As shown in Table 1, the metal collecting material of the present invention exhibits excellent collecting ability.

The metal collecting material of the present invention can industrially recover or remove useful or harmful metal dissolved in a liquid, and can selectively collect specific metal at high speed and in large quantity. Furthermore, the collecting material of the present invention has characteristics of capable of collecting an intended metal element by a simple contact method, excelling in handling ability, and having low environmental load due to dissipation of the collecting material by falling of the collected metal, breaking or tearing of the collecting material, or the like. A useful element dissolved in hot spring water, seawater and the like can be used as a resource. Furthermore, harmful metal contained in various effluents can be collected and removed.

What is claimed is:

1. A metal collecting material formed of an organic polymer fiber base material into which a functional group having a metal adsorbing function is introduced, wherein the metal collecting material has a nonwoven fabric form, an opening diameter of 10 to 300 μm, an aperture ratio of 10 to 50%, a thickness of 10 to 500 μm, and a weight per area of 5 to 25 g/m², and a fiber diameter of the organic polymer fiber is 5 to 50 μm.

2. The metal collecting material according to claim 1, wherein the functional group is introduced by using a graft polymerization method using radiation or plasma treatment.

3. The metal collecting material according to claim 1, wherein a degree of swelling when collecting metal is 150 to 2000%.

4. The metal collecting material according to claim 1, wherein the organic polymer fiber is cellulose.

5. The metal collecting material according to claim 4, wherein the cellulose is viscose rayon or cuprammonium rayon.
